(19) United States
(12) Patent Application Publication
(10) Pub. No.: US 2026/0131699 A1
(43) Pub. Date: May 14, 2026

(54) SYSTEM AND METHOD FOR CONTROLLING CHARGING OF BATTERY

(71) Applicants: Hyundai Motor Company, Seoul (KR); Kia Corporation, Seoul (KR)

(72) Inventor: Jin Gyu LIM, Hwaseong-Si (KR)

(21) Appl. No.: 19/279,614

(22) Filed: Jul. 24, 2025

(30) Foreign Application Priority Data
Nov. 13, 2024 (KR) 10-2024-0160684

(51) Int. Cl. B60L 58/27; B60L 53/16; B60L 53/62; B60L 53/66; H01M 10/46; H01M 10/615; H01M 10/625; H01M 10/633; H01M 50/249

(52) U.S. Cl. CPC B60L 58/27; B60L 53/16; B60L 53/62; B60L 53/66; H01M 10/46; H01M 10/615; H01M 10/625; H01M 10/633; H01M 50/249; B60L 2240/545; H01M 2220/20

(57) ABSTRACT

Disclosed is a system for controlling charging of a battery. The system includes a charger configured to charge the battery configured to supply an energy for powering a vehicle, a heater configured to heat the battery, and a controller configured to communicate with the battery and the charger, and configured to control the operation of the heater based on specification information of the charger.

### CROSS-REFERENCE TO RELATED APPLICATION

This application claims, under 35 U.S.C. § 119(a), the benefit of and priority to Korean Patent Application No. 10-2024-0160684, filed on Nov. 13, 2024, the entire contents of which are incorporated herein by reference.

### TECHNICAL FIELD

The present disclosure relates to controlling charging of a battery.

### BACKGROUND

Electric vehicles driven by motors are widely spreading. An electric vehicle may include a motor and a rechargeable battery configured to supply energy for powering the motor.

In order to power an electric vehicle, the battery must be periodically charged. Therefore, unlike an internal combustion engine vehicle, the charging performance of the battery in the electric vehicle is an important factor to consider in terms of the commercial value or operation of the electric vehicle.

The charging performance of a battery is greatly affected by the temperature of the battery. Particularly, the charging performance of a battery may be significantly reduced at a low-temperature condition (e.g., weather conditions in winter). For this reason, an electric vehicle may be equipped with a heater configured to increase the temperature of the battery so that the battery is maintained at an appropriate temperature.

In addition to simply increasing the temperature of the battery using the heater to improve the charging performance, a charging strategy to improve the charging performance or charging efficiency depending on given external conditions is needed.

The above information disclosed in this Background sector is only for enhancement of understanding of the background of the present disclosure, and therefore it may contain information that does not form the prior art that is already known to one having ordinary skill in the art.

### SUMMARY

The present disclosure has been made in an effort to solve the above-described problems, and an object of the present disclosure is to provide a system and method for controlling charging of a battery capable of improving the charging performance and charging efficiency of the battery.

Another object of the present disclosure is to provide a system and method for controlling charging of a battery capable of securing robustness of charging under a low-temperature condition, like in winter.

The object(s) of the present disclosure is not limited to the foregoing, and other objects not mentioned herein will be understood by one having ordinary skill in the art to which the present disclosure pertains based on the description below.

The features of the present disclosure to achieve the object of the present disclosure as described above and to perform the characteristic functions of the present disclosure to be described later are as follows.

According to some forms of the present disclosure, a system for controlling charging of a battery includes a charger configured to charge the battery configured to supply an energy for powering a vehicle, a heater configured to heat the battery, and a controller configured to communicate with the battery and the charger, and configured to control the operation of the heater based on specification information of the charger.

According to some forms of the present disclosure, a method for controlling charging of a battery includes collecting, by a controller, specification information of a charger and state information of the battery configured to supply an energy for powering a vehicle, and controlling, by the controller, the operation of a heater configured to heat the battery, based on the specification information of the charger.

Other aspects and preferred embodiments of the present disclosure are discussed infra.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed infra.

### BRIEF DESCRIPTION OF THE DRAWINGS

The above and other features of the present disclosure will now be described in detail with reference to certain embodiments thereof shown in the accompanying drawings which are given herein below by way of illustration only, and thus are not limitative of the present disclosure, and wherein:

FIG. 1 is a diagram of an example system for controlling charging of a battery of a vehicle;

FIG. 2 is a flowchart of controlling charging of a battery of a vehicle; and

FIG. 3 is a flowchart of controlling charging of a battery of a vehicle.

FIG. 4 shows an example computing system of a vehicle.

It should be understood that the appended drawings are not necessarily to scale, presenting a somewhat simplified representation of various preferred features illustrative of the basic principles of the present disclosure. The specific design features of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

Descriptions of specific structures or functions presented in the present disclosure are merely exemplary for the purpose of explaining the embodiment(s) according to the concept of the present disclosure, and the feature of the present disclosure may be implemented in various forms. In addition, the descriptions should not be construed as being limited to the embodiment(s) described herein, and should be understood to include all modifications, equivalents and substitutes falling within the idea and scope of the present disclosure.

Meanwhile, in the present disclosure, terms such as “first” and/or “second” may be used to describe various components, but the components are not limited by the terms. These terms are only used to distinguish one component from another. For example, a first component could be termed a second component, and similarly, a second component could be termed a first component, without departing from the scope of embodiment(s) of the present disclosure.

It will be understood that, when a component is referred to as being “connected to” or “brought into contact with” another component, the component may be directly connected to or brought into contact with the other component, or intervening components may also be present. In contrast, when a component is referred to as being “directly connected to” or “brought into direct contact with” another component, there is no intervening component present. Other terms used to describe relationships between components should be interpreted in a like fashion (e.g., “between” versus “directly between”, “adjacent” versus “directly adjacent”, etc.).

Throughout the specification, like reference numerals indicate like components. The terminology used herein is for the purpose of illustrating various features of the present disclosure and is not intended to limit the present disclosure. In this specification, the singular form includes the plural sense, unless specified otherwise. The terms “comprises” and/or “comprising” used in this specification mean that the cited component, step, operation, and/or element does not exclude the presence or addition of one or more of other components, steps, operations, and/or elements.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Hereinafter, the present disclosure is described in detail with reference to the accompanying drawings.

In at least some temperature increase logic during slow or rapid charging of a battery, the temperature of the battery was increased using a heater with an aim of reaching a set temperature which does not change regardless of the charger's specifications. When the charger's rating is relatively small, the temperature of the battery only needs to be raised to a temperature that can hold the corresponding charging specifications, but there were cases where the heater was unnecessarily activated because the charger's rating/specifications was not taken into consideration. In addition to the unnecessary energy consumption, excessive operation of the heater was directly related to the charging costs, degrading the commercial value of the vehicle.

The specifications of the charger may include various pieces of information associated with charging capabilities. For example, the specifications of the charger may include at least one of: the maximum power output (e.g., 350 kW, 250 kW), nominal grid voltage (e.g., nominal grid voltage for input & output), grid type, frequency (e.g., 60 Hz), nominal battery energy, nominal output power (e.g., AC), maximum apparent power, overcurrent protection device, maximum continuous charge current, maximum output fault current, maximum short-circuit current rating, connectivity (e.g., Wi-Fi, Ethernet, Cellular, etc.), operating temperature (e.g. −20° C. to 50° C.).

The present disclosure provides a system and method for providing a strategy of thermal management and charging of a battery in which the temperature to activate a heater is changed depending on the charger's specifications. Specifically, the present disclosure provides a system and method configured to maximally utilize the charger's specifications to improve the charging performance and prevent a heater from being unnecessarily activated, thereby improving charging efficiency.

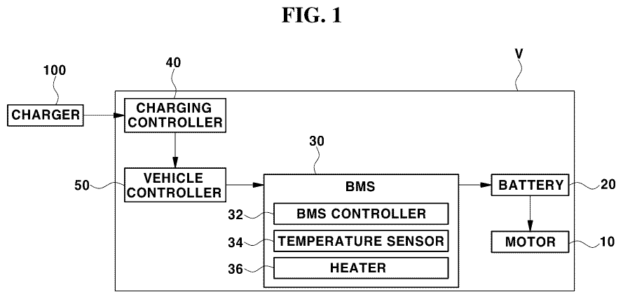

As shown in FIG. 1, a vehicle V includes a motor 10 and a battery 20. The motor 10 is configured to drive the vehicle V. In an example, the motor 10 may provide a rotational power to a drive shaft of the vehicle V. In another example, the motor 10 may be an in-wheel motor mounted in a wheel of the vehicle V. The battery 20 may be a rechargeable secondary battery. In an example, the battery 20 may be charged with electric energy through (e.g., provided from) a charger 100. The battery 20 may be configured to supply power for driving the vehicle V and may be distinguished from an auxiliary battery.

The vehicle V may be an electric vehicle or any other types of vehicles equipped with one or more batteries and a motor (e.g., a hybrid vehicle, a fuel-cell vehicle, etc.). In an example, the vehicle V may be a pure electric vehicle and may not include an internal combustion engine. In another example, the vehicle V may be a plug-in hybrid electric vehicle and may include an internal combustion engine. According to an implementation of the present disclosure, the vehicle V may be referred to as a battery system. In one implementation, the battery system may include the battery 20. In one implementation, the battery system may include the battery 20 and high-voltage electric components (or power electronics) of the battery 20. In one implementation, the battery system may include the battery 20, the high-voltage electric components of the battery 20, thermal management system of the battery 20, a system for managing the battery 20, a low-voltage direct current converter, and the like. In other words, the battery system may include related high-voltage components, including the battery 20 of the vehicle V.

The vehicle V includes a battery management system (BMS) 30. The BMS 30 is configured to collect state information of the battery 20 and control the operation of the battery 20 based on the collected state information. To this end, the BMS 30 may include a BMS controller 32. The BMS controller 32 may collect state information of the battery 20. In order to maintain the battery 20 in an optimal state, the BMS controller 32 may operate components of the BMS 30 or external components, or may execute a series of pre-stored commands. In an example, the BMS 30 or the BMS controller 32 may collect a state of charge (SOC) of the battery 20. The BMS 30 may collect information indicating the temperature of the battery 20 measured by a temperature sensor 34. A plurality of temperature sensors 34 may be arranged on the battery 20. The plurality of temperature sensors 34 may be mounted throughout the battery 20. In one implementation, the BMS 30 may include a heater 36. The heater 36 may heat up the battery 20 to increase the temperature of the battery 20. The BMS 30 may further include additional components configured to monitor and control the battery 20. However, in this specification, components of the BMS 30 that are less relevant to the present disclosure are not described.

The vehicle V may include a charging controller 40. The charging controller 40 is configured to communicate with the charger 100. In one implementation, the charging controller 40 may collect the specification information of the charger 100. In an example, the specification information of the charger 100 includes a maximum output, voltage, current, or any combination thereof of the charger 100.

The charging controller 40 (or any other controller of the vehicle) may communicate with the charger 100 (e.g., an external charger in a charging station) via one or more communication interfaces. The charging controller 40 may communicate with the charger 100 via a wired communication interface when with the charger 100 is connected to a charger connecter of the vehicle V. The wired communication line may be included a cable of the charger 100 and may be electrically connected to the charging connector of the vehicle V. The charging controller 40 may communicate with the charger 100 via the wired connection. Alternatively, or additionally, the charging controller 40 (or any other controller of the vehicle) may communicate with the charger 100 via a wireless communication interface. The charging controller 40 may receive the specification information of the charger 100 and/or other data from the charger 100 via the wireless communication interface regardless of whether the charger 100 is connected to the vehicle V.

Communication interface(s) (also referred to as communication device(s), communicator(s), communication module(s), communication unit(s), etc.) may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

One or more controllers described herein may include a communication device communicating with other controllers or a sensor to control one or more functions and/or operations in charge, a memory storing an operation system, a logic command, and input/output information, and/or one or more processors performing determination, calculation, and decision necessary for controlling the function in charge. A controller may include, for example, a processor, a central processing unit (CPU), a microchip, a logic, an application-specific integrated circuit (ASIC), memory, etc. A controller may manipulate and/or control other components in the system (e.g., vehicle).

One or more power electronic parts may be equipped in the vehicle V. The one or more power electronic parts may include various vehicles parts (e.g., inverter, converter, motor controller, power distribution unit, high-voltage wiring and connectors, auxiliary power modules, charging interface, ADAS, autonomous driving controller, etc.)

One or more sensors may be equipped in the vehicle V. The sensor(s) may include, for example, a charger connection sensor, a voltage sensor, a current sensor, a power sensor, a camera, a LIDAR, a radar, an infrared sensor, an infrared camera, a thermal imaging camera, a blind spot monitoring sensor, a line departure warning sensor, a parking sensor, a light sensor, a rain sensor, a traction control sensor, an anti-lock braking system sensor, a tire pressure monitoring sensor, a seatbelt sensor, an airbag sensor, a fuel sensor, an emission sensor, a throttle position sensor, a gyroscope, a speedometer, a magnetometer, etc. The sensor may be used, for example, for battery management control, battery charging control, battery preconditioning control, monitoring surrounding environments and/or autonomous driving control. For example, the one or more sensors may detect the maximum output power of the charger and/or the actual power output by the charger connected to the vehicle V. The one or more sensors may also detect the voltage and/or current output by the charger connected to the vehicle V. The one or more sensors may detect the maximum charging power of one or more batteries of the vehicle V, and may detect the actual charging power of one or more batteries of the vehicle V. The one or more sensors may also detect the voltage and/or current applied to the one or more batteries of the vehicle V.

A BMS (e.g., the BMS controller 32) may perform a preconditioning operation for the battery of the vehicle V by operating a battery heater, for example, before the charger is connected to the vehicle V. The vehicle (e.g., the charging controller and/or the BMS) may receive the specification information of the charger via a wireless communication. One or more algorithms and/or logics described herein may be used for the preconditioning operation for the battery of the vehicle V.

The vehicle V includes a vehicle controller 50 (e.g., including one or more processors and memory). Among other things, the vehicle controller 50 may perform thermal management of the battery 20. In one implementation, the vehicle controller 50 is configured to communicate with the BMS 30. The vehicle controller 50 may receive state information of the battery 20 from the BMS controller 32 and may control, based on the state information, the operation of the BMS 30 by itself or through the BMS controller 32. For example, the vehicle controller 50 may be configured to activate the heater when needed. In one implementation, the vehicle controller 50 is configured to communicate with the charging controller 40. The vehicle controller 50 may collect the specification information of the charger 100 connected to the vehicle V from the charging controller 40.

In the above, it is described that the BMS controller 32, the charging controller 40, and the vehicle controller 50 are implemented as separate controllers. However, the controllers 32, 40, and 50 may be implemented as a single integrated controller (e.g., including one or more processors and memory). Also, the controllers 32, 40, and 50 each may include one or more controllers configured to perform the same function.

According to an implementation of the present disclosure, the vehicle controller 50 may control the operation of the heater 36 based on a comparison between the maximum output of the charger 100 and the maximum charging power of the vehicle V. The maximum output of the charger 100 may include the maximum power the charger 100 is able to output for charging a battery (e.g., 350kW). The maximum output of the charger 100 may be determined based on a product of a voltage of the charger 100 and a current of the charger 100 to provide the maximum power for charging a battery. The maximum charging power of the vehicle V may be the maximum power that can be received by a battery of the vehicle V (e.g., 240 kW).

In at least some implementations, in response to the maximum output of the charger 100 connected to the vehicle V being greater than the maximum charging power of the vehicle V (for example, it may be assumed that the maximum output of the charger 100 is 350 kW and the maximum charging power of the vehicle V (e.g., a value derived through an actual vehicle test) is 240 kW), the vehicle controller 50 may activate the heater 36 until the temperature of the battery 20 reaches a predetermined target temperature (e.g., 20° C.). According to the present disclosure, if the maximum output of the charger 100 is greater than the maximum charging power of the vehicle V, the target temperature may be set to a temperature at which the maximum charging current is generated. In other words, because the output of the charger 100 is sufficient, the temperature at which the vehicle V can output the maximum charging performance is set as a target temperature and the battery 20 may be heated up to the target temperature. The target temperature may be a predetermined value (e.g., a configured temperature value, a preconfigured temperature value, etc.). As the target temperature, a temperature value in which the maximum current is provided (e.g., based on the charging map of the battery 20) may be selected as the target temperature.

In at least some implementations, in response to the maximum output of the charger 100 connected to the vehicle V being smaller than the maximum charging power of the vehicle V (for example, a case where the maximum output of the charger 100 is 50 kW and the maximum charging power of the vehicle V is 240 kW, etc.), the vehicle controller 50 may differently set a condition to activate the heater 36 from a condition to deactivate the heater 36. In one implementation, as the condition to activate the heater 36, the vehicle controller 50 may be configured to activate the heater 36 in response to a state in which the actual charging power of the vehicle V stays smaller than the maximum charging power of the charger 100 (e.g., for a predetermined period of time). Here, the actual charging power of the vehicle V may be calculated as a sum of the power of the battery 20 and the power of other (high-voltage) electric components (or power electronics) in the vehicle V. For example, the actual charging power of the vehicle V may be obtained by summing the actual charging power of the battery 20 (e.g., a value of the product of the voltage of the battery 20 and the current of the battery 20), the power consumed by a low-voltage dc-dc converter (LDC), the power consumed by thermal management components (heating, ventilation, air-conditioning (HVAC) system, the heater 36, etc.) of the battery 20, and the power consumed by other high-voltage electric components. As the condition to deactivate the heater 36, the vehicle controller 50 may deactivate the heater 36 in response to a state in which the actual charging power of the vehicle V stays equal to or greater than the maximum charging power of the charger 100 (e.g., for a predetermined period of time). In this example, the power consumed by the high-voltage electric components is also considered in addition to the actual charging power of the battery 20 in order to take into account heat loss due to resistance in the electric circuit.

In at least some implementations, as the condition to activate the heater 36, the vehicle controller 50 may be configured to activate the heater 36 in response to a state in which the actual charging power of the battery 20 stays smaller than the maximum charging power of the charger 100 or the maximum output of the charger 100 for a predetermined period of time (e.g., 30 seconds) or longer. In an example, the vehicle controller 50 may deactivate the heater 36 in response to a state in which the actual charging power of the battery 20 stays equal to or greater than the maximum charging power of the charger 100 for a predetermined period of time (e.g., 30 seconds) or longer, or the temperature of the battery 20 exceeds a predetermined temperature (e.g., 20° C.) . Here, the actual charging power of the battery 20 may be obtained by multiplying the charging voltage of the battery 20 by the charging current of the battery 20. In an example, the vehicle controller 50 may receive the charging voltage and the charging current of the battery 20 from the BMS 30 to calculate the actual charging power of the battery 20 based on the received values. In the present disclosure, the battery 20 may mean only the battery 20 itself, but may also mean both the battery 20 and the high-voltage electric component, e.g., the power electronics.

In at least some implementations, if it is not possible to collect the specification information of the charger 100 from the charger 100, the vehicle controller 50 may operate the heater 36 until the temperature of the battery 20 reaches a predetermined target temperature (e.g., like in the case where the maximum output of the charger 100 is greater than the maximum charging power of the vehicle V). For example, the target temperature may be 20° C., and the heater 36 may deactivated when the temperature of the battery 20 reaches approximately 20° C. after the heater 36 is activated.

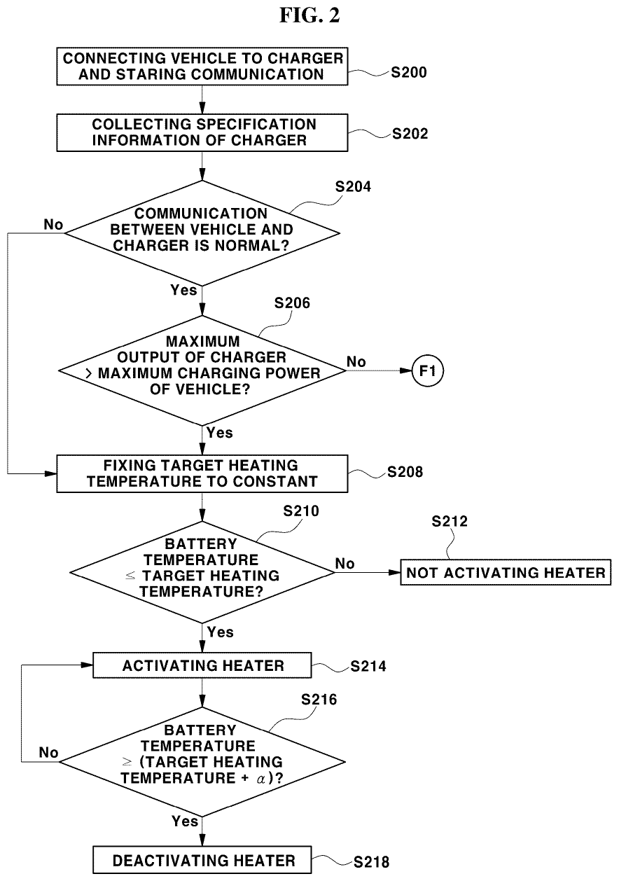

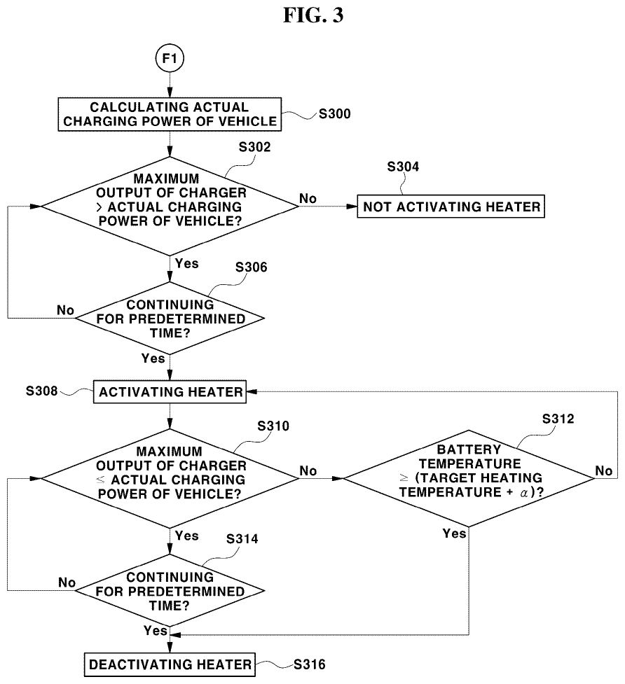

Hereinafter, a method for controlling charging of a battery of a vehicle is described by referring to FIG. 2 and FIG. 3.

As shown in FIG. 2, at operation S200, the vehicle V is connected to the charger 100 and communication between the vehicle V and the charger 100 is initiated. The communication between the vehicle V and the charger 100 may begin when/after a charging connector of the charger 100 is connected to a charging terminal (e.g., provided in the vehicle V).

At operation S202, the charging controller 40 may communicate with the charger 100 and may collect the specification information of the charger 100. As described above, the specification information of the charger 100 may include the maximum output, voltage, current, or any combination thereof of the charger 100.

At operation S204, a controller (e.g., the charging controller 40 or the vehicle controller 50) determines whether the communication between the vehicle V and the charger is normal. If the charging controller 40 is able to receive the specification information of the charger 100, it may be determined that the communication between the vehicle V and the charger 100 is normal. If the communication between the vehicle V and the charger 100 is not normal, the vehicle controller 50 may set a target heating temperature to a configured value (e.g., a constant, a preset value, etc.) and control the operation of the heater 36 as in the operation S208 and thereafter. Whether the communication between the vehicle V and the charger 100 is normal may be determined based on whether charging is possible. For example, when the communication is not normal, battery charging does not occur or is not successful even when the charger 100 is connected to the vehicle V. In some implementations, the maximum output of the charger 100 used in the following operations may be a smaller value between i) the maximum power configured to be output by the charger 100 and ii) the product of voltage and current, among the information obtained from the charger 100.

At operation S206, based on (e.g., in response to) the communication being normal, the vehicle controller 50 receives the specification information of the charger 100 from the charging controller 40 and compares the maximum output of the charger 100 in the received specification information with the maximum charging power of the vehicle V. The maximum charging power of the vehicle V is a value determined through an actual vehicle test and may be stored as a predetermined value in the vehicle controller 50. When/if it is determined that the maximum output of the charger 100 is smaller than or equal to the maximum charging power of the vehicle V, the vehicle controller 50 may perform control according to the processes after the block F1 shown in FIG. 3.

When/if it is determined that the maximum output of the charger 100 is greater than the maximum charging power of the vehicle V, the vehicle controller 50 may perform operation S208. At operation S208, the vehicle controller 50 may set (e.g., fix) the target heating temperature to a constant. As described above, in this case, as the output of the charger 100 is greater than the maximum charging power of the vehicle, the temperature at which the maximum charging performance of the vehicle V can be achieved is set as a target heating temperature, and the battery 20 may be heated up to the target heating temperature. The target heating temperature (e.g., 20° C.) may be close to a room temperature (e.g., 18° C. to 22° C.).

At operation S210, the vehicle controller 50 receives information indicating the current temperature of the battery 20 from the BMS 30. The vehicle controller 50 may be configured to determine whether the received temperature of the battery 20 is smaller than or equal to the target heating temperature. Here, the temperature of the battery 20 may be the smallest value (or the average) among the temperatures of the battery 20 measured by the plurality of temperature sensors 34.

In response to the temperature of the battery 20 being greater than the target heating temperature, the vehicle controller 50 may be configured not to activate (or to deactivate) the heater 36 at operation S212.

In response to the temperature of the battery 20 being smaller than or equal to the target heating temperature, the vehicle controller 50 may be configured to activate the heater 36, at operation S214. While the heater 36 is operating, the vehicle controller 50 may be configured to collect information indicating the temperature of the battery 20 in real time. The vehicle controller 50 may be configured to determine whether the temperature of the battery 20 collected in real time has reached a stop temperature, which may be a value that is the target heating temperature plus a buffer value α (e.g., α=0.5° C., 1° C., 2° C., etc.), at operation S216. Here, the buffer value α may be a hysteresis temperature condition for reactivating the heater 36. This temperature condition may be determined by a test and is a control value that may prevent excessive reactivation of the heater 36. The vehicle controller 50 continues operating the heater 36 until the temperature of the battery 20 reaches the stop temperature. When/if the temperature of the battery 20 reaches the stop temperature, the vehicle controller 50 may deactivate the heater 36 at operation S218. Here, the temperature of the battery 20 may be the smallest value (or the average) among the temperatures of the battery 20 measured by the plurality of temperature sensors 34.

At operation S206, if it is determined that the maximum output of the charger 100 is smaller than or equal to the maximum charging power of the vehicle V, the vehicle controller 50 may be configured to control the operation of the heater 36 according to the processes after the block F1 shown in FIG. 3. In this case where the maximum charging power specification that the vehicle V can hold is greater than the maximum output of the charger 100, the temperature may be increased to a temperature at which the output specification of the charger 100 can be held. For example, the temperature of the battery may be increased to a temperature at which the charger 100 efficiently charges the battery with the maximum output (e.g., the maximum power output) of the charger 100.

At operation S300, the vehicle controller 50 may be configured to calculate the actual charging power of the vehicle V. As described above, the actual charging power of the vehicle V may be obtained by summing the charged power of the battery 20 and the power consumed by the high-voltage electric components. The charging controller 40 may collect the charged power of the battery 20 and the power consumed by each high-voltage electric component and transmit the information to the vehicle controller 50.

At operation S302, the vehicle controller 50 may be configured to compare the maximum output of the charger 100 with the actual charging power of the vehicle V. In response to the maximum output of the charger 100 being smaller than the actual charging power of the vehicle V, the vehicle controller 50 may keep the heater 36 in a non-activated state, at operation S304.

In response to the maximum output of the charger 100 being greater than the actual charging power of the vehicle V, the vehicle controller 50 may be configured to monitor whether the state in which the maximum output of the charger 100 being greater than the actual charging power of the vehicle V continues for a predetermined period of time, at operation S306. In response to the state continuing for the predetermined period of time, the vehicle controller 50 may be configured to activate the heater 36, at operation S308. In an example, the heater 36 may be activated only when satisfying both conditions where the maximum output of the charger 100 being greater than the actual charging power of the vehicle V and such a state continuing for the predetermined period of time.

At operation S310 (and in at least one operation after operation S320), whether to deactivate the heater 36 may be determined. At operation S310, the vehicle controller 50 may be configured to compare whether the maximum output of the charger 100 is smaller than or equal to the actual charging power of the vehicle V.

When/if the maximum output of the charger 100 is greater than the actual charging power of the vehicle V, the vehicle controller 50 is configured to determine whether the current temperature of the battery 20 is smaller than or equal to the stop temperature (e.g., the value obtained by adding the buffer value α to the target heating temperature), at operation S312. When/if the temperature of the battery 20 is determined to be smaller than the stop temperature, the vehicle controller 50 may be configured to continuously operate the heater 36. When/if the temperature of the battery 20 is determined to be equal to or greater than the stop temperature, the vehicle controller 50 may be configured to deactivate the heater 36, at operation S316.

In response to the maximum output of the charger 100 being smaller than or equal to the actual charging power of the vehicle V, the vehicle controller 50 may be configured to monitor whether the state in which the maximum output of the charger 100 being smaller than or equal to the actual charging power of the vehicle V continues for a predetermined period of time, at operation S314. In response to the state in which the maximum output of the charger 100 being smaller than or equal to the actual charging power of the vehicle V continues for a predetermined period of time, the vehicle controller 50 may be configured to deactivate the heater 36, at operation S316.

According to at least some implementations, in the example configuration of FIG. 3, the actual charging power of the battery 20 may be used instead of the actual charging power of the vehicle V.

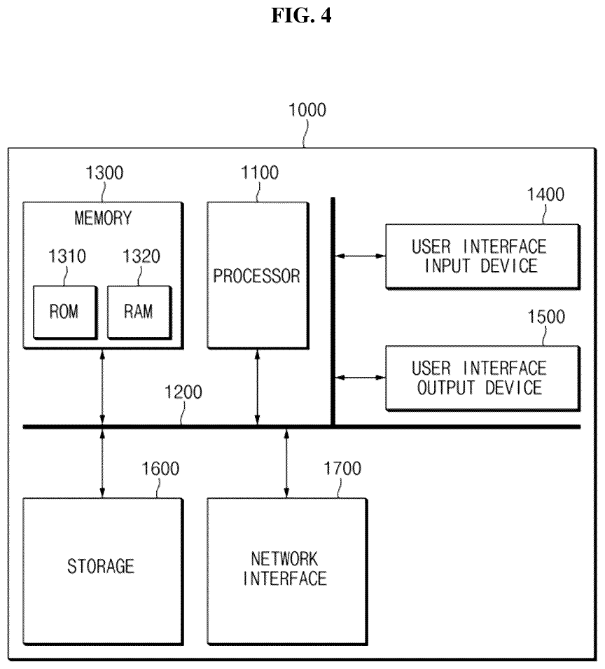

FIG. 4 shows an example computing system of a vehicle. The one or more controllers described herein may be implemented by a computing system.

Referring to FIG. 4, a computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The system and method according to one or more aspects of the present disclosure may increase the charging efficiency when charging a battery. According to one or more aspects of the present disclosure, the temperature to activate the heater is set differently depending on the charger's specifications, minimizing unnecessary energy consumption and increasing the charging efficiency, thereby reducing charging costs.

The system and method according to one or more aspects of the present disclosure may improve the charging performance during charging. According to one or more aspects of the present disclosure, the temperature of the battery 20 of the vehicle V is managed so as to maximize the charger's output specifications, increasing charging power to thereby reduce charging time. Charging performance deteriorates under low-temperature conditions, but according to one or more aspects of the present disclosure, charging performance may be maximized, particularly in winter.

The system and method according to one or more aspects of the present disclosure may secure robustness of charging in low temperature environments (e.g., weather conditions in winter). When attempting charging in an extremely low temperature environment, charging may not occur or charging may be interrupted. According to one or more aspects of the present disclosure, such situations may be prevented, improving the reliability of the vehicle.

As is apparent from the above description, the present disclosure provides the following effects.

According to one or more aspects of the present disclosure, a system and method for controlling charging of a battery capable of improving the charging performance and charging efficiency of the battery are provided.

According to one or more aspects of the present disclosure, a system and method for controlling charging of a battery capable of securing robustness of charging under a low-temperature condition, like winter, are provided.

Effects of one or more aspects of the present disclosure are not limited to what has been described above, and other effects not mentioned herein will be clearly recognized by those skilled in the art based on the above description.

It will be apparent to those of ordinary skill in the art to which the present disclosure pertains that the present disclosure described above is not limited by the above-described embodiment(s) and the accompanying drawings, and various substitutions, modifications and changes are possible within a range that does not depart from the technical idea of the present disclosure.

What is claimed is:

1. A vehicle comprising:
a charger connector configured to connect to an external charger, wherein the external charger is configured to charge a battery of the vehicle;
a heater configured to heat the battery; and
a controller configured to communicate with the battery and the external charger, wherein the controller is configured to control, based on specification information of the external charger, an operation of the heater.

2. The vehicle of claim 1, wherein the specification information of the external charger comprises a maximum output, voltage, current, or a combination thereof of the external charger.

3. The vehicle of claim 2, wherein the controller is configured to control the operation of the heater based on the maximum output power of the external charger and a predetermined maximum charging power for the battery of the vehicle.

4. The vehicle of claim 2, wherein, based on the maximum output power of the external charger being greater than a predetermined maximum charging power for the battery of the vehicle, the controller is configured to control the heater such that a temperature of the battery reaches a target temperature.

5. The vehicle of claim 4, wherein the controller is configured to activate the heater based on the temperature of the battery being less than or equal to the target temperature.

6. The vehicle of claim 5, wherein, based on the temperature of the battery reaching a stop temperature greater than the target temperature, the controller is configured to deactivate the heater.

7. The vehicle of claim 2, wherein, based on the maximum output power of the external charger being less than or equal to a predetermined maximum charging power for the battery of the vehicle, the controller is configured to:
determine an actual charging power for the battery of the vehicle, and
control the operation of the heater based on the actual charged power.

8. The vehicle of claim 7, wherein the controller is configured to:
compare the maximum output power of the external charger with the actual charging power, and
based on determining that a first state in which the maximum output power of the external charger is greater than the actual charging power is maintained for a predetermined first time period, activate the heater.

9. The vehicle of claim 8, wherein the controller is configured to:
compare the maximum output power of the external charger with the actual charging power while the heater is operating, and
based on determining that a second state in which the maximum output power of the external charger is less than or equal to the actual charging power is maintained for a predetermined second time period, deactivate the heater.

10. The vehicle of claim 8, wherein the controller is configured to:
compare the maximum output power of the external charger with the actual charging power while the heater is operating,
based on the maximum output power of the external charger being greater than the actual charging power, compare a temperature of the battery with a predetermined stop temperature, and
based on the temperature of the battery being equal to or greater than the predetermined stop temperature, deactivate the heater.

11. The vehicle of claim 7, wherein the controller is configured to:
compare the maximum output power of the external charger with the actual charging power, and
based on the maximum output power of the external charger being less than or equal to the actual charging power, maintain a deactivated state of the heater.

12. The vehicle of claim 7, wherein the actual charging power is calculated based on a sum of an actual charged amount of power into the battery and an amount of power consumed by an electric component related to the battery.

13. A method performed by an apparatus of a vehicle, the method comprising:
receiving, by a controller of the vehicle from an external charger connected to a charger connector of the vehicle, specification information of the external charger;
receiving, by the controller, state information of a battery of the vehicle; and
controlling, by the controller, an operation of a heater, of the vehicle, that is configured to heat the battery, based on the specification information of the external charger.

14. The method of claim 13, further comprising:
comparing a maximum output power in the specification information of the external charger with a predetermined maximum charging power for the battery of the vehicle; and
based on the maximum output power being greater than the predetermined maximum charging power, heating the battery to a constant target temperature using the heater.

15. The method of claim 14, further comprising activating the heater based on a temperature of the battery is less than or equal to the target temperature.

16. The method of claim 15, further comprising:
comparing the temperature of the battery with a predetermined stop temperature while the heater is operating; and
based on the temperature of the battery being equal to or greater than the predetermined stop temperature, deactivating the heater.

17. The method of claim 13, further comprising:
comparing a maximum output power in the specification information of the external charger with a predetermined maximum charging power for the battery of the vehicle;
based on the maximum output power being less than or equal to the predetermined maximum charging power, determining an actual charging power for the battery of the vehicle; and
based on the actual charging power, controlling the operation of the heater.

18. The method of claim 17, further comprising:
comparing the maximum output power of the external charger with the actual charging power;
based on a first state in which the maximum output power of the external charger is greater than the actual charging power, determining whether the first state is maintained for a predetermined first time period; and
based on the first state being maintained for the predetermined first time period, activating the heater.

19. The method of claim 18, further comprising:
comparing the maximum output power of the external charger with the actual charging power while the heater is operating;
based on the maximum output power being greater than the actual charging power, comparing a temperature of the battery with a predetermined stop temperature; and
based on the temperature of the battery being equal to or greater than the predetermined stop temperature, deactivating the heater.

20. A vehicle comprising:
a motor;
a battery configured to provide power to the motor;
a battery heater configured to heat the battery;
a charger connector configured to connect to an external charger, wherein the external charger is configured to charge the battery; and
a processor configured to:
receive specification information of the external charger indicating a maximum output power of the external charger;
identify a maximum charging power for the battery; and
control, based on a comparison of the maximum output power of the external charger and the maximum charging power for the battery, an operation of the battery heater.
